(19) United States
(12) Patent Application Publication
(10) Pub. No.: US 2025/0199842 A1
(43) Pub. Date: Jun. 19, 2025

(54) CONFORMING DIGITAL DOCUMENTS TO STYLE GUIDES

(71) Applicant: Grammarly, Inc., San Francisco, CA (US)

(72) Inventors: Vivek Kulkarni, Mountain View, CA (US); Claudia Leacock, New York, NY (US); Dimitrios Alikaniotis, New York, NY (US); Maxim Gubin, Danville, CA (US)

(21) Appl. No.: 18/977,100

(22) Filed: Dec. 11, 2024

Related U.S. Application Data
(60) Provisional application No. 63/609,423, filed on Dec. 13, 2023.

(51) Int. Cl. G06F 9/455; G06F 9/54

(52) U.S. Cl. CPC G06F 9/45558; G06F 9/54

(57) ABSTRACT

In an embodiment, non-transitory computer-readable storage media store one or more sequences of instructions which, when executed using one or more processors, cause the one or more processors to execute: executing a document processing application; receiving a digitally stored electronic document, alone or in combination with one or more other relevant documents, and an engineered prompt; transmitting an application programming interface (API) call to an API of a pre-trained large language model (LLM), wherein the call comprises the engineered prompt, wherein the engineered prompt comprises a plurality of objective instructions to the pre-trained LLM specifying transforming the electronic document according to a style guide to cause the pre-trained LLM to execute an inference stage over the electronic document and automatically generate output text based on the electronic document and the plurality of objective instructions that transforms the electronic document to conform to the style guide; storing the output text using a storage device of a user computer, a hosted storage environment, or in memory associated with the document processing application.

### CROSS-REFERENCE TO RELATED APPLICATIONS

This application claims the benefit under 35 U.S.C. 119 (e) of provisional application 63/609,423, filed Dec. 13, 2023, the entire contents of which are hereby incorporated by reference for all purposes as if fully set forth herein.

### COPYRIGHT NOTICE

A portion of the disclosure of this patent document contains material that is subject to copyright protection. The copyright owner has no objection to the facsimile reproduction by anyone of the patent document or the patent disclosure, as it appears in the Patent and Trademark Office patent file or records, but otherwise reserves all copyright or rights. @ 2023 Grammarly, Inc.

### TECHNICAL FIELD

One technical field of the present disclosure is natural language processing (NLP) tasks using artificial intelligence (AI) and machine learning systems. Another technical field is prompt engineering for large language models (LLMs) and generative AI systems.

### BACKGROUND

The approaches described in this section are approaches that could be pursued but not necessarily approaches that have been previously conceived or pursued. Therefore, unless otherwise indicated, it should not be assumed that any approaches described in this section qualify as prior art merely by their inclusion.

Instruction-tuned large language models (LLMs) have achieved improved performance on various NLP tasks and are used extensively in many NLP applications, including writing assistants. However, little is known about their ability to follow fine-grained instructions consistently and rigorously, especially text editing instructions. Modern large-scale language models (LLMs) have been aligned to follow instructions. Such LLMs have shown the ability to perform several tasks like sentiment classification, question answering, text summarization, and machine translation when these tasks are described as instructions in suitable prompts (Wang et al., 2018, 2019; Hendrycks et al., 2020; Surameery and Shakor, 2023).

Despite instruction-tuned LLMs being used very widely, engineers and product managers do not clearly understand their instruction-following capability. Prior work on rigorously evaluating the instruction-following ability of LLMs is relatively scarce (Webson and Pavlick, 2022; Min et al., 2022; Kung and Peng, 2023; Li et al., 2023). Kung et al. (2023) suggest that some instruction-fine-tuned models might rely less on the instructions than previously thought but instead latch onto superficial artifacts like output format. Li et al. (2023) find that the influence of prior knowledge encoded in the training stage can limit the steerability of models. Still, a fundamental question remains: How good are current LLMs at following instructions? How does their effectiveness vary with the number of instructions, complexity, and the dependence relations between instructions?

Based on the foregoing, the referenced technical fields have developed an acute need for better ways to follow fine-grained text editing instructions.

### SUMMARY

The appended claims may serve as a summary of the invention.

### BRIEF DESCRIPTION OF THE DRAWINGS

In the drawings:

FIG. 1 illustrates factors for considering the performance of a large language model (LLM) in following instructions expressed in a prompt in one embodiment.

FIG. 2 is a bar graph illustrating data representing the overall performance of selected LLMs in following instructions that are expressed in a prompt.

FIG. 3 is a line graph illustrating the effect of input length on the performance of LLMs.

FIG. 4 is a bar graph illustrating the effect of model size on performance.

FIG. 5 is a bar graph illustrating LLM accuracy for a plurality of tasks when using a mixture-of-experts approach.

FIG. 6 is a bar graph illustrating the performance of models on the miniAP-1 and miniAP-N-1 tasks, broken down by two major error classes.

FIG. 7 is a line graph showing performance versus the number of instructions for the edit-N task.

FIG. 8 is a bar graph that illustrates the performance of LLAMA models with supervised fine-tuning on specified tasks.

FIG. 9 illustrates a distributed computer system showing the context of use and principal functional elements with which one embodiment could be implemented.

FIG. 10 illustrates a computer system with which one embodiment could be implemented.

### DETAILED DESCRIPTION

In the following description, for the purposes of explanation, numerous specific details are set forth in order to provide a thorough understanding of the present invention. It will be apparent, however, that the present invention may be practiced without these specific details. In other instances, well-known structures and devices are shown in block diagram form in order to avoid unnecessarily obscuring the present invention.

The text of this disclosure, in combination with the drawing figures, is intended to state in prose the algorithms that are necessary to program the computer to implement the claimed inventions at the same level of detail that is used by people of skill in the arts to which this disclosure pertains to communicate with one another concerning functions to be programmed, inputs, transformations, outputs and other aspects of programming. That is, the level of detail set forth in this disclosure is the same level of detail that persons of skill in the art normally use to communicate with one another to express algorithms to be programmed or the structure and function of programs to implement the inventions claimed herein.

This disclosure may describe one or more different inventions, with alternative embodiments to illustrate examples. Other embodiments may be utilized, and structural, logical, software, electrical, and other changes may be made without departing from the scope of the particular inventions. Various modifications and alterations are possible and expected. Some features of one or more of the inventions may be described with reference to one or more particular embodiments or drawing figures, but such features are not limited to usage in the one or more particular embodiments or figures with reference to which they are described. Thus, the present disclosure is neither a literal description of all embodiments of one or more inventions nor a listing of features of one or more inventions that must be present in all embodiments.

Headings of sections and the title are provided for convenience but are not intended to limit the disclosure in any way or as a basis for interpreting the claims. Devices described as in communication with each other need not be in continuous communication with each other unless expressly specified otherwise. In addition, devices that communicate with each other may communicate directly or indirectly through one or more intermediaries, logical or physical.

A description of an embodiment with several components in communication with one other does not imply that all such components are required. Optional components may be described to illustrate a variety of possible embodiments and to illustrate one or more aspects of the inventions fully. Similarly, although process steps, method steps, algorithms, or the like may be described in sequential order, such processes, methods, and algorithms may generally be configured to work in different orders unless specifically stated to the contrary. Any sequence or order of steps described in this disclosure is not a required sequence or order. The steps of the described processes may be performed in any order practical. Further, some steps may be performed simultaneously. The illustration of a process in a drawing does not exclude variations and modifications, does not imply that the process or any of its steps are necessary to one or more of the invention(s), and does not imply that the illustrated process is preferred. The steps may be described once per embodiment but need not occur only once. Some steps may be omitted in some embodiments or occurrences, or some steps may be executed more than once in a given embodiment or occurrence. When a single device or article is described, more than one device or article may be used in place of a single device or article. Where more than one device or article is described, a single device or article may be used instead of more than one device or article.

The functionality or features of a device may be alternatively embodied by one or more other devices that are not explicitly described as having such functionality or features. Thus, other embodiments of one or more inventions need not include the device itself. Techniques and mechanisms described or referenced herein will sometimes be described in singular form for clarity. However, it should be noted that particular embodiments include multiple iterations of a technique or manifestations of a mechanism unless noted otherwise. Process descriptions or blocks in figures should be understood as representing modules, segments, or portions of code, including one or more executable instructions for implementing specific logical functions or steps in the process. Alternate implementations are included within the scope of embodiments of the present invention in which, for example, functions may be executed out of order from that shown or discussed, including substantially concurrently or in reverse order, depending on the functionality involved.

### 1. GENERAL OVERVIEW

Using a benchmark suite that enables a controlled evaluation, the inventors have discovered, in an inventive moment, that state-of-the-art LLMs show varied performance and can struggle on even elementary text editing tasks revealing key insights into the limitations of current LLMs. The disclosure shows that further instruction tuning on text-editing instruction data can effectively improve performance on both seen and unseen text-editing tasks. The disclosure also presents embodiments of a computer system and computer-implemented method to automatically transform an input text to conform to a specified style guide.

Various embodiments encompass the subject matter of the following numbered clauses:

13. One or more non-transitory computer-readable storage media storing one or more sequences of instructions which, when executed using one or more processors, cause the one or more processors to execute: executing a document processing application; receiving a digitally stored electronic document, alone or in combination with one or more other relevant documents, and an engineered prompt; transmitting an application programming interface (API) call to an API of a pre-trained large language model (LLM), wherein the API call comprises the engineered prompt, wherein the engineered prompt comprises a plurality of objective instructions to the pre-trained LLM specifying transforming the electronic document according to a style guide to cause the pre-trained LLM to execute an inference stage over the electronic document and automatically generate output text based on the electronic document and the plurality of objective instructions that transforms the electronic document to conform to the style guide; and storing the output text using a storage device of a user computer, a hosted storage environment, or in memory associated with the document processing application.

14. The one or more non-transitory computer-readable storage media of clause 13, wherein the pre-trained LLM is any of a ChatGPT model, a GPT4 model, and a LLAMA2-13B model.

15. The one or more non-transitory computer-readable storage media of clause 13, wherein the document processing application is communicatively coupled via a network to the user computer, which hosts or executes a browser or word processor to create and store the electronic document.

16. The one or more non-transitory computer-readable storage media of clause 15, further comprising sequences of instructions which, when executed using the one or more processors, cause the one or more processors to execute: receiving a query for one or more documents that conform to a specified style guide; transmitting the query to a knowledge base that digitally stores text documents that the user computer has created and stored in states before or after transformation according to the style guide; in response to the query, creating and returning a result set of the one or more other relevant documents; transmitting the one or more other relevant documents via the API to the pre-trained LLM with a prompt to fine-tune the LLM, thereby causing the pre-trained LLM to create and return, or digitally store, a fine-tuned model; and using the fine-tuned model, receiving the electronic document as input and processing a request to automatically transform the electronic document according to the specified style guide.

17. The one or more non-transitory computer-readable storage media of clause 16, further comprising sequences of instructions which, when executed using the one or more processors, cause the one or more processors to execute: transmitting a query to the knowledge base to retrieve a result set of the one or more other relevant documents corresponding to prior transformations of documents according to a specified style guide; transmitting a processing request to the API, the processing request comprising: a copy of the electronic document to be transformed according to the specified style guide; the result set of the one or more other relevant documents; and the engineered prompt; and receiving, from the pre-trained LLM, automatically generated text that has been transformed according to the style guide.

18. The one or more non-transitory computer-readable storage media of clause 13, wherein the engineered prompt comprises one of a plurality of different prompts digitally stored in prompt storage and retrieved in response to a programmatic request from the document processing application.

19. The one or more non-transitory computer-readable storage media of clause 13, wherein the engineered prompt comprises a task description, a query, and a plurality of examples of transformations.

20. The one or more non-transitory computer-readable storage media of clause 19, wherein the engineered prompt comprises 10 to 1,000 examples of transformations.

21. The one or more non-transitory computer-readable storage media of clause 13, wherein the engineered prompt comprises a task description, a query, and at least: one or more first instructions specifying punctuation usage; one or more second instructions specifying abbreviation style; one or more third instructions specifying capitalization style; and one or more fourth instructions specifying number style.

22. The one or more non-transitory computer-readable storage media of clause 13, wherein the engineered prompt comprises 6 to 16 instructions.

23. The one or more non-transitory computer-readable storage media of clause 13, wherein the digitally stored electronic document comprises five or fewer sentences.

24. The one or more non-transitory computer-readable storage media of clause 13, wherein the pre-trained LLM comprises 70 billion or more parameters.

### 2. STRUCTURAL & FUNCTIONAL OVERVIEW

The following sections and the attached drawing figures are intended to illustrate the functional level at which skilled persons in the art to which this disclosure pertains communicate with one another to describe and implement a computer-implemented method, as described further herein and/or algorithms using programming. The flow diagrams are not intended to illustrate every instruction, method object, or sub-step that would be needed to program every aspect of a working program but are provided at the same functional level of illustration that is normally used at the high level of skill in this art to communicate the basis of developing working programs.

Embodiments provide new technical means for automatically applying communication styles to digitally stored electronic documents based on digital style guides and engineered prompts to an LLM. Characterizing the ability of LLMs to follow a set of instructions is useful in many practical text-editing applications where multiple operations need to be performed in one interaction. For example, given an input document, one might want to correct formatting and grammar, improve clarity, and rewrite to a specific tone. More generally, improving the ability of LLMs to follow a set of (complex) instructions would enable LLMs to rewrite text according to specific style guides, such as the Associated Press Style Guide, the Chicago Manual of Style, or others. Such style guides contain several instructions outlining how text must be written to conform to the specific style. They are adopted by publishing companies, businesses, and media houses to ensure consistency across their communications.

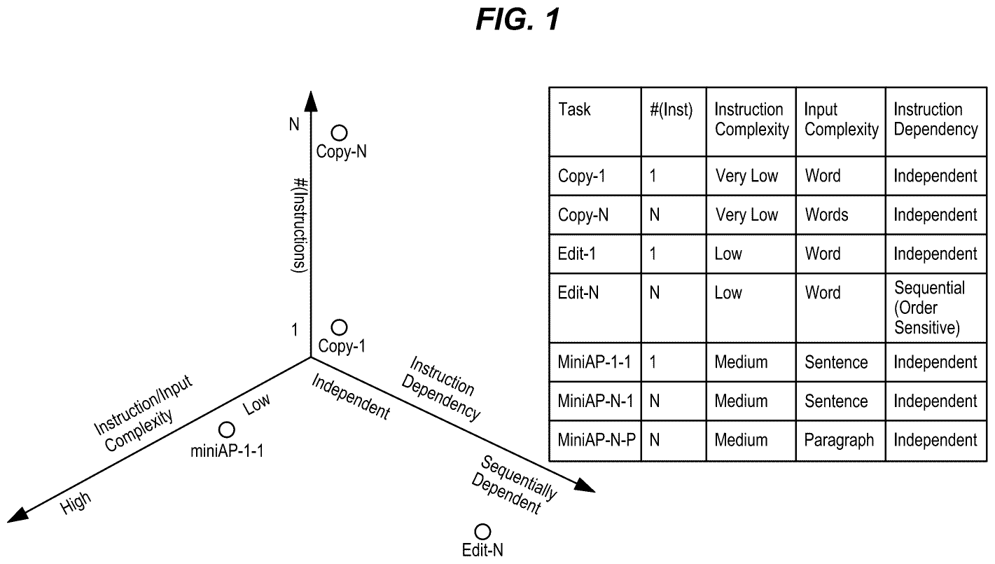

Embodiments can be based on data derived from a suite of text-editing tasks and associated benchmarks to probe the instruction-following ability of these models. One embodiment can use three dimensions to probe model performance and deliberately design text editing tasks that assess model performance in a controlled manner across representative points in the space spanned by these dimensions, as shown in FIG. 1. Experiments have shown that model performance varies distinctly on these text editing tasks, and even the best models can struggle on specific instructions. Experiments have shown that:
1. LLMs find many text editing tasks (some even elementary) challenging, with performance being negatively correlated with instruction complexity and input length. Introducing dependencies between instructions (especially sequential ones) poses even more challenges.
2. OpenAI models generally outperform LLAMA2 models. Larger models also tend to perform better, reinforcing the importance of model scaling.
3. Further fine-tuning text-editing instruction data can significantly improve model performance over the baseline on both seen and unseen text editing tasks.

Embodiments provide new insights into the instruction-following ability of LLMs, introducing new tasks and evaluation protocols for evaluating the ability of LLMs to follow text editing instructions—an ability that is at the heart of writing assistants.

### 2.1 Following Text Editing Instructions—Example Setup—Main Tasks

In an embodiment, a main set of text editing tasks falls into two major groups described below. FIG. 1 also provides a summary. One is elementary text editing, and the second is practical text editing.

### 2.1.1 Elementary Text Editing Tasks

Elementary text editing tasks, in an embodiment, comprise synthetic text editing tasks that perform elementary string manipulation where each instruction is very simple, the expected output is completely unambiguous, and evaluation data can be very easily constructed computationally.

Copy. In this task, a list of instructions asks the LLM to output a specific sequence of tokens. The task helps probe model performance when: (a) each instruction is almost trivial in complexity and (b) every instruction is completely independent of others. An example sequence of instructions (in a single interaction) for this task is shown below:
Execute the following instructions:
<instruction> Output the sequence of tokens enclosed between <token> and </token> on a new line: <token>cat</token>
<instruction> Output the sequence of tokens enclosed between <token> and </token> on a new line: <token>house</token>
Output:
Two Copy-1 and Copy-N correspond to settings with single and multiple instructions, respectively.

Edit. We consider a list of instructions that transform (edit) a source string to a target string in terms of only INSERT/DELETE/REPLACE instructions on indices of the source. Such instructions can be efficiently computed using the classic Fisher-Wagner algorithm. An example list of instructions that transforms “coastal” to “postal” is shown below:

Execute the below instructions.
All position indexes mentioned are 0-based.
<instruction> Set s to coastal </instruction> <instruction> Replace
the character at position 0 of s with p and set s to the new string
obtained. </instruction>
<instruction> Delete the character at position 2 of s and set s to
the new string obtained. </instruction>
<instruction> Output only the string s </instruction>
Output:

In contrast to the Copy task, even though each instruction is fairly simple (although not trivial), there is a strict sequential dependency on instructions where each instruction theoretically operates on the intermediate output of the prior instruction. Two settings, Edit-1 and Edit-N, correspond to settings with single and multiple instructions, respectively.

Finally, for both tasks, an embodiment can generate a test (N: 1000) and a training set (N: 10000, token/tuple disjoint from the test) with varying task parameters.

### 2.1.2 Practical Text Editing Tasks (Miniap)

Instructions on text editing and manipulation are mentioned in popular language style guides like the AP (Associated Press) and MLA (Modern Language Association) style guides. Instructions mentioned in the AP style guide can be represented in a task denoted miniAP. In an embodiment, the task digitally encodes a set of instructions listed in the AP style guide related to the usage of (a) Punctuation, (b) Abbreviations, (c) Capitalization, (d) Plurals, (e) Number formatting, and (f) Date and Time formatting. An example is shown in TABLE 5 below. The instructions for these dimensions are relatively unambiguous; compliance can be computationally verified, and collecting relevant data is easier. Instructions related to other dimensions, like clarity, tone, and sensitivity, tend to be subjective and require human evaluation but could be encoded or used in other embodiments. The following example illustrates model instructions from the above set, identifies an input text, and asks an LLM to rewrite the text to comply with the provided instructions.

Rewrite the text enclosed between <QASD> and
</QASD> so that it complies with the provided
style guide.
<styleguide>
<instruction> Write single-digit numbers in
words. </instruction>
</styleguide>
<QASD>
I bought 9 apples.
</QASD>
Output:

Embodiments can consider three settings with increasing complexity as follows. The task miniAP-1-1 considers exactly one instruction and one input sentence. This corresponds to the easiest configuration. In the task miniAP-N-1, the model is provided multiple instructions, but the input is a single sentence. This is a slightly more challenging setting since the majority of the instructions may not apply to the provided input sentence. Models need to ignore inapplicable instructions but still correctly apply the mostly one (or rarely few) applicable instructions. In the task miniAP-N-P, the model has multiple instructions and multiple input sentences (a paragraph of five sentences). This extends the multiple instruction setting above in that the input text is larger and has multiple (potentially) non-compliant sentences. Both miniAP-N-1 and miniAP-NP settings resemble a realistic use case where a user might provide several instructions from a style guide and ask that the LLM rewrite input as necessary to comply.

To generate test and training instances when needed, the SELFINSTRUCT paradigm can be used (Wang et al., 2022). An LLM with a public API, such as GPT-4, can generate candidate sentences related to a linguistic dimension (e.g., number usage). Then, regular expressions can manipulate these candidate sentences to obtain versions compliant and non-compliant with the specific instruction, optionally with a manual review for correctness. These steps create a dataset containing triplets of the form (a style guide instruction, non-compliant sentence, compliant version) and correspond to the miniAP-1-1 setting. To construct datasets for the other two settings, this dataset is modified as follows: For the miniAP-N-1 setting, replace the instruction field to contain all instructions. We further manually edit the compliant version if needed to ensure global compliance. Similarly, to construct a paragraph-level dataset (the miniAP-N-P setting), we randomly sample a batch of instances and concatenate the corresponding tuples, based on using a paragraph size of five sentences in experiments. For each setting, a test set (N: 1000) and a training set (N: 10000) instance are generated, ensuring that the train and test sets are recorded disjoint. Finally, to evaluate the ability of models not to make erroneous edits to compliant input, all datasets contain some instances where the input text already conforms to the provided instructions and no edits are needed.

### 2.2 Additional Tasks and Data

Two additional text-editing tasks can evaluate the ability of text-editing instruction fine-tuned LLM models to generalize to new instructions/tasks.

miniAP-reversed Task. This set of instructions is formed from the miniAP-1-1 task by negating the original instructions and swapping the target and the input, thus asking the model to execute the reverse of the original instruction.

UpperLower task (UL) Task. The task and settings are identical to the Edit task but have one major change. Instead of instructions that insert, delete, or replace characters at specific indices and have sequential dependencies, the task comprises instructions that only transform characters to upper-case or lower-case characters at specific indexes. Furthermore, the instances are designed such that the final output does not theoretically depend on the instruction application order.

GENERIC-TE is a large-scale diverse text-editing instruction dataset. Prior works like ALPACA (Taori et al., 2023) have demonstrated that instruction fine-tuning on a very diverse set of instructions improves model performance on various downstream NLP tasks. Experiments can investigate the effect of instruction fine-tuning on a large, diverse set of text-editing instructions. In an embodiment, a dataset of 50,000 instances of instructions follows data largely adapting the process outlined in (Taori et al., 2023), except that in the SELFINSTRUCT, the model is asked to only focus on text-editing instructions while still focusing on generating diverse instruction set related to a large variety of linguistic dimensions like tone or sensitive language. This data is used only for supervised fine-tuning and not for evaluation since this dataset spans linguistic dimensions where evaluation can be subjective.

### 2.3 Evaluation Details

Prompting Strategy. The instructions and the input text are encoded in a prompt like the examples above, accommodating minor variations that may be needed, such as removing the system prompt. A best-effort approach to prompt engineering is acceptable, incorporating known best practices to design prompts. An implicit but practical assumption is that “prompt engineering effort” negatively correlates with “model steering/instruction-following ability.” Therefore, when a model requires extensive prompt engineering to follow instructions, intuitively, it implies the model is not as steerable and so ranks lower than a model that requires lesser effort.

Evaluation Metric. To measure the ability of models to follow text editing instructions precisely, an exact match with the compliant text is defined as a measure of success and accuracy. To maximize success potential, models can be flexible on the output format, and an embodiment can be programmed to perform appropriate output post-processing. The models are expected to be largely consistent in their output format. For example, some models output rewritten text between <output></output>tags, while some just output the rewritten text.

### 3. MODELS

Experiments have used (a) ChatGPT, (b) GPT4, and (c) LLAMA2. ChatGPT and GPT-4 are closed models, but they are considered to be state-of-the-art and thus establish strong practical baselines. However, because these models are closed, embodiments can address the effect of aspects like (a) model scale, (b) training procedures, and (c) training data. In contrast, LLAMA2 is an open model, with the 13B model being representative. The chat variant of LLAMA2 can be used since the base model is not instruction fine-tuned. The 13B variant is an expedient choice and also more representative of practical use cases.

### 4. ZERO-SHOT PERFORMANCE

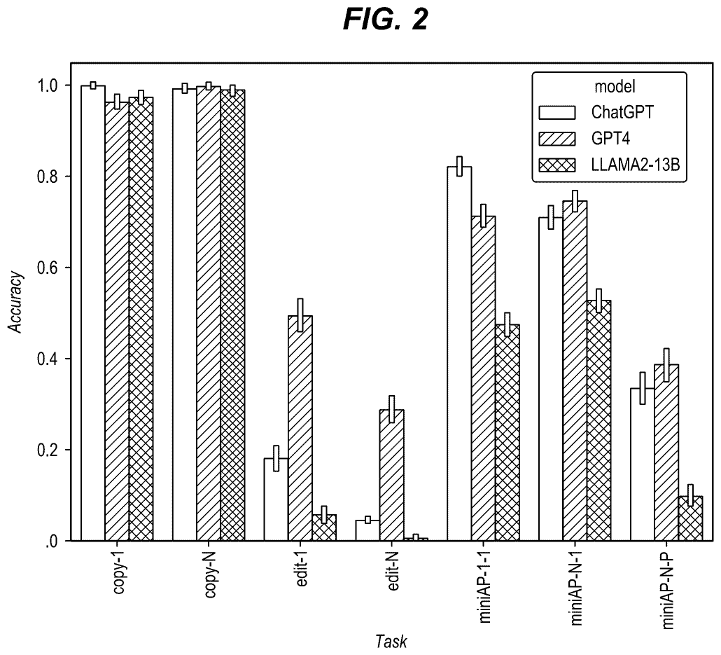

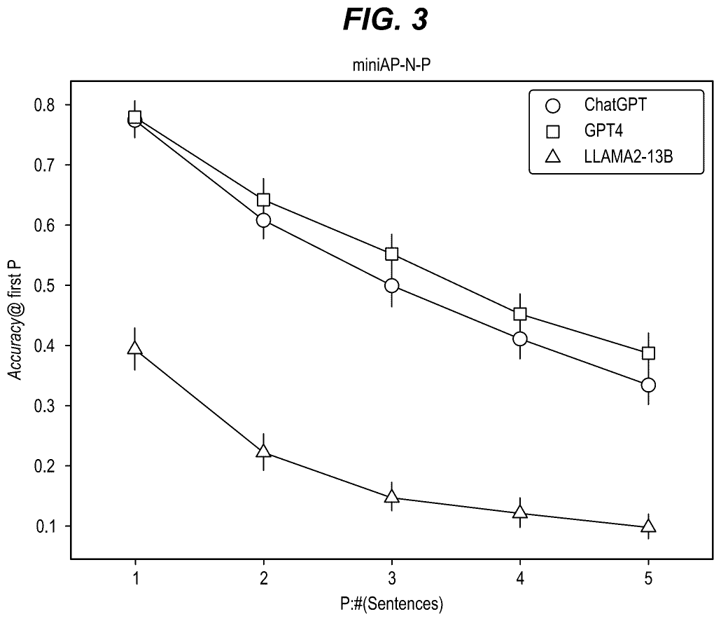

Overall Performance. FIG. 2 shows the performance of the models in the various text editing tasks outlined in Section 2. FIG. 2 illustrates the overall performance of models on following text editing instructions. Models achieve relatively high accuracy when asked to follow a single instruction or when the instructions are simple. However, they struggle in following multiple instructions, or on larger inputs. FIG. 3 illustrates the effect of input length on the performance of models. Accuracy at the first P sentences on the miniAP-N-P task. Note that as input text length increases, performance drops and all models display very similar trends. The following further observations have been made:

All models perform the Copy task almost perfectly. Recall that this task involves instructions where (a) each instruction is almost trivial in complexity and (b) instructions are completely independent. This suggests that very low instruction complexity and independence correlate with higher performance.

All models find the Edit task challenging, where even performance on the single instruction setting (edit-1) is low. Prior work has noted that LLMs (including GPT4) may still struggle at seemingly elementary tasks like counting, article swapping, and shift ciphers (McCoy et al., 2023). Acting on index-based string editing operations is likely yet another task. Furthermore, performance drops even further in the multiple instruction setting, suggesting that sequential dependencies between instructions can be challenging for current LLMs. Such models need to operate implicitly on intermediate outputs, thus introducing more points of failure.

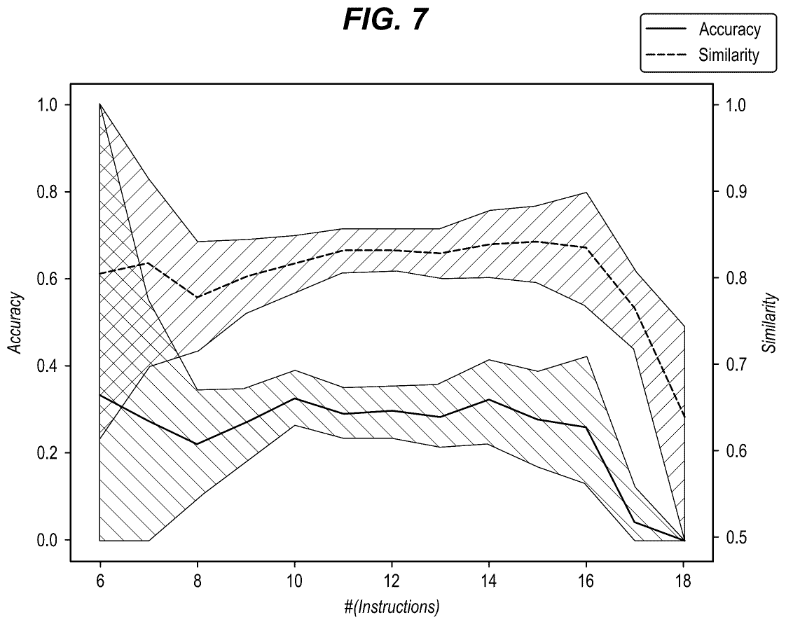

The poor performance on the single instruction case is still only about 50% (GPT-4). This suggests that both ChatGPT and GPT4 find it challenging to follow basic operations on characters at specific indices consistently (note even with explicit instructions that 0-based indexing is used. Using explicit CoT and implicit CoT prompting also did not yield significant improvement). Second, sequential dependency between instructions can be additionally challenging because models need to maintain an internal scratch buffer since the output at any step depends on the intermediate output at the previous instruction. Therefore, the final predicted output is likely to be close in “edit-distance” similarity to the expected output, and the accuracy and “edit-distance” similarity should drop as the number of instructions increases. FIG. 7 shows the accuracy and a measure of edit-distance-based similarity on the test set stratified by a number of instructions. Indeed, we note that while the accuracy is low as expected, the edit-distance similarity is higher (closer to 0.6) and suggests that many characters in the predicted output match the characters from the expected output with a few errors. The similarity measure is 2M T, which will be between 0 and 1. M is the total number of character matches, and T is the total of characters in both the prediction and the expected strings.

On the miniAP tasks: (a) Performance on the single instruction, single sentence setting (miniAP-1-1) is generally higher than the other settings (miniAP-N-*), revealing a clear trend that model performance decreases as the input size increases. This observation further supports the observation around the general challenges of LLMs handling long contexts (Liu et al., 2023). The effect of how performance drops as input length increases is revealed by analyzing performance at first P sentences shown in FIG. 3.

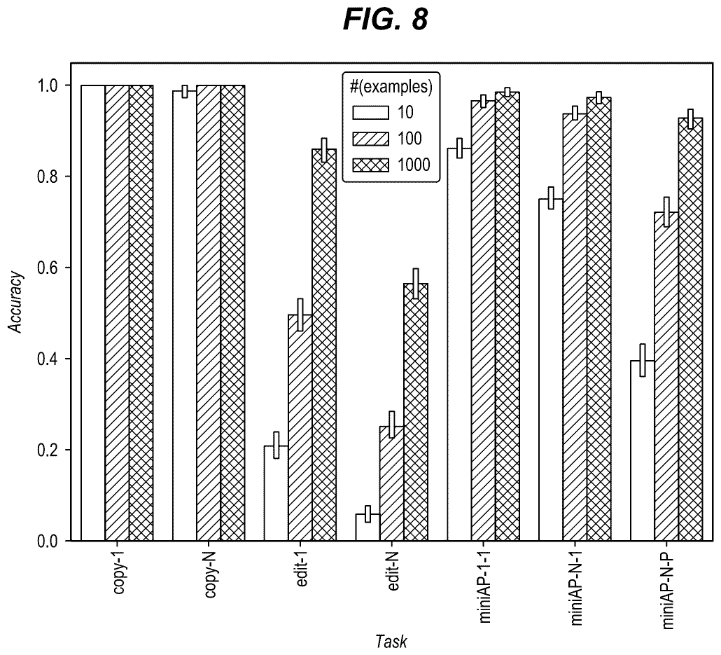

Finally, OpenAI models outperform LLAMA2 on average. Between ChatGPT and GPT4, GPT4 generally performs similarly to ChatGPT except for the Edit task, for which GPT4 significantly outperforms ChatGPT. FIG. 8 is a bar graph that illustrates the performance of LLAMA models with supervised fine-tuning on specified tasks. FIG. 8 shows the performance of LLAMA models as a function of the number of training examples per seen task in the supervised fine-tuned setting. Note that for simple tasks like the Copy task, only 10 examples are sufficient to guide the model to learn the specific task. In settings with multiple instructions or instructions with sequential dependencies, one might need up to 1000 examples.

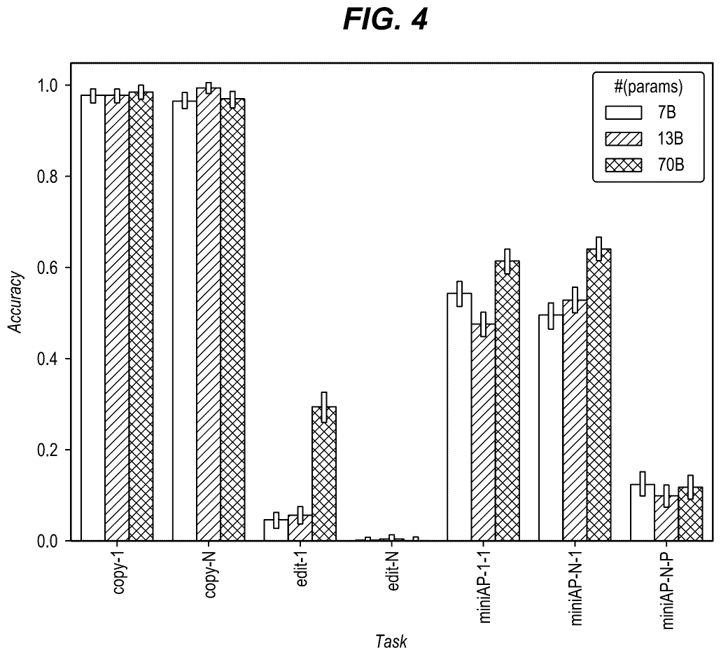

Effect of Model Scale. FIG. 4 shows the impact of model size on performance from which we can draw the following conclusions: On very simple tasks like the copy task, lower size models perform as well as larger ones. On other tasks that involve non-trivial instructions, the 7B and the 13B models generally perform equivalently. The largest model (70B) shows a clear benefit overall (especially on the edit-1, miniAP-1-1, and miniAP-N-1 tasks), suggesting that model scaling might yield improvements beyond specific thresholds.

Effect of Instruction Alignment with Prior Knowledge. Because LLMs are trained on extremely massive amounts of text (and potentially instructions) from diverse sources, including the Internet, one might conjecture that LLMs might have internalized many of the miniAP style instructions since they are generally dominantly reflected in language usage. Thus, to what extent is model performance a reflection of instructions being well-aligned with prior knowledge potentially internalized by models during their training phase? An embodiment can be programmed to measure model performance on counterfactual instructions that likely deviate from the LLM prior. The miniAP-reversed task consists of precisely these counterfactual instructions. TABLE 1 shows the result of this evaluation. A significant drop occurs in the performance of ChatGPT (0.82 versus 0.61) and LLAMA2 (0.47 versus 0.25) in the counterfactual setting compared to the likely well-aligned miniAP setting. This suggests that there is a significant effect of model priors on model performance, and these models are harder to override. GPT4, however, shows some drop but not a significant drop (0.71 versus 0.68), indicating that GPT4 likely is a more steerable model than the others.

TABLE 1
Performance of models degrades when the instructions
are not well-aligned with model priors

ACCURACY

| | MINIAP | REVERSED MINIAP |
|---|---|---|
| MODEL | (NATURAL) | (COUNTERFACTUAL) |
| CHATGPT | 0.82 | 0.61 |
| LLAMA2-7B | 0.54 | 0.43 |
| LLAMA2-13B | 0.47 | 0.25 |
| LLAMA2-70B | 0.61 | 0.47 |
| GPT4 | 0.71 | 0.68 |

TABLE 2
Error buckets of models on the miniAP task. Both model
families struggle with instructions related to number
formatting and punctuation, among others.

ERROR

| DIMENSION | CHATGPT | LLAMA2 |
|---|---|---|
| Year abbreviation | 7.6 | 7.3 |
| Title abbreviation | 4.8 | 6.3 |
| Punctuation | 15.2 | 21.6 |
| Plural possessive | 24.2 | 7.5 |
| Number formatting | 23.6 | 21.3 |
| Colon | 18.5 | 17.0 |
| Capitalization | 6.2 | 19.0 |

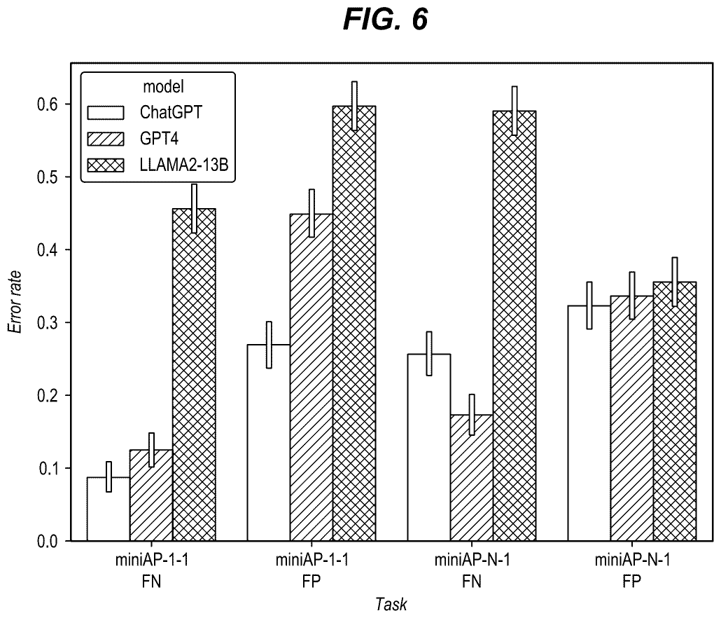

miniAP Task Error Analysis. An error analysis of models on the miniAP task considers two main kinds of errors: false negatives, where the model either misses or makes incorrect edits on non-compliant input, and false positives, where the model erroneously makes edits to fully compliant input. FIG. 6 shows the error rates for each of these classes for all models in the miniAP-*-1 settings. We focus on single-sentence settings since it is easier to analyze errors in a single sentence and are representative. Significant differences exist between the models. LLAMA2 performs worse than the OpenAI models. Second, comparing ChatGPT and GPT4, in the miniAP-1-1 setting, GPT4 tends to have a significantly higher false-positive rate than ChatGPT, indicating it is more aggressive than ChatGPT at making edits. However, in the multiple instruction setting of miniAP-N-1, GPT4 has significantly lower false negatives than ChatGPT, indicating it is better at both detecting and rewriting instances to be compliant in the presence of multiple instructions.

FIG. 6 shows the performance of models on miniAP-1-1 and miniAP-N-1 tasks broken down by two major error classes: (a) False Negatives (FN): Error rate on instances with non-compliant input; and (b) False Positives (FP): Error rate on instances with already compliant input text and no edits were expected to be made.

What linguistic dimensions pose the most challenge? Table 2 shows the breakdown of the errors on the miniAP-1-1 task for representative models from both model families. All models generally find instructions related to abbreviations easier than others. Instructions related to plural possessives, number formatting, and colon usage tend to pose quite a challenge for all models. This is likely because these instructions are nuanced and complex, consisting of many conditions outlining exceptions.

Instruction Application via Code Generation. Having observed that LLMs find several text editing instructions, many of which are simple deterministic rules challenging to follow, experiments can explore whether LLM task performance improves by leveraging the code-generation ability of LLMs to translate applicable human-readable instructions to Python programs that can be executed deterministically. A mixture-of-experts approach can be used

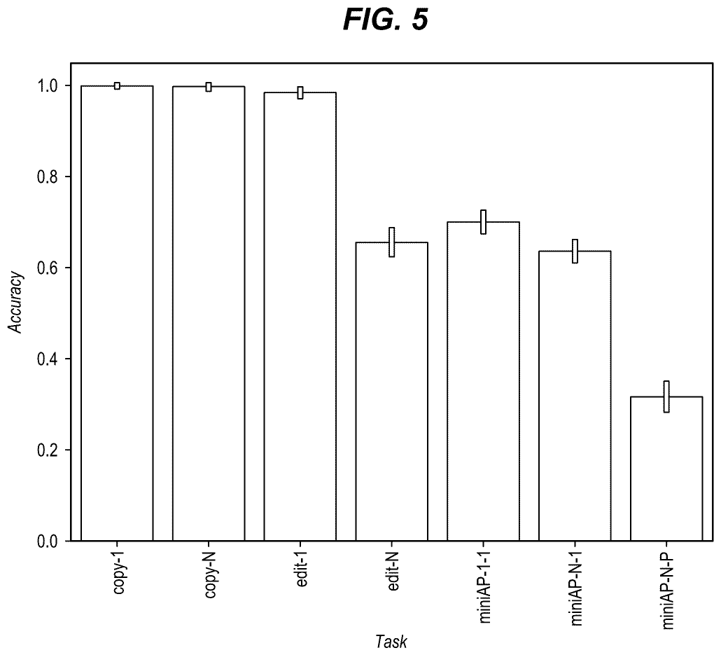

First, given the set of instructions, the LLM is prompted to decide which subset of instructions can be implemented as Python functions and generate relevant Python code that, when executed on an input, applies that subset. The application of the full set of instructions then has two steps—(a) Apply the subset of instructions that are encoded as Python functions by sampling executing those functions on the input string and (b) Apply the remaining instructions defaulting to the prompting strategy. FIG. 5 shows the results of this approach using GPT4, which is known to be significantly better at code generation over ChatGPT and CodeLLAMA.

Overall results are mixed. Note the significant improvement in performance on the Edit-1 (0.99 vs. 0.5) and Edit-N (0.6 vs. 0.2) tasks relative to our default prompting approach. GPT4 results in FIG. 2 can be compared. This is because GPT4 almost perfectly generates the correct code that implements these operations. However, on the miniAP tasks, the overall performance is slightly worse because it generates incorrect code for some instructions (e.g., number formatting). This approach will be effective when instructions are deterministic, and LLMs can translate human-readable instructions to correct executable code with a high enough precision to offset the error rate of the default strategy.

### 5. DOES SUPERVISED FINE-TUNING HELP?

Significant gaps exist in model performance in the zero-shot setting. Therefore, an experiment can investigate whether further fine-tuning on potentially task-specific instructions following data helps boost performance. How well do such fine-tuned models generalize to unseen tasks like those outlined in Section 2.2? Further supervised fine-tuning considering task mixtures that progressively increase the number of held-out tasks can include:
all-main: Use instructions from all tasks outlined in Section 2.1.
1-Inst: Only use data from single instruction settings from the tasks outlined in Section 2.1. This setting assesses whether models trained only on single instructions generalize to multiple instruction settings.
miniAP-held-out: Use data from all tasks outlined in Section 2.1, except the miniAP task; instead, include GENERIC-TE, the large-scale generic text editing instruction dataset.
all-held-out: Hold out all tasks and only train on GENERIC-TE.

For each main task included, an experiment can use 1,000 training examples per task and use all examples from GENERIC-TE when it is included.

### 5.1 Fine-Tuning Procedure

In one experiment, the LLAMA2 (13B) model is fine-tuned using instruction-based fine-tuning and a “completions-only” loss where the loss is computed only on the expected completion (output tokens), although all tokens are attended. This encourages the model to focus on learning to generate the required output rather than learning to auto-complete parts of the input. One experimented trained all models for one epoch on one A100 instance with eight GPUs using a per-device batch size of eight.

### 5.2 Evaluation

Overall Performance. Tables 3 and 4 show the performance of instruction fine-tuned models.

TABLE 3
Average performance of LLAMA models on all tasks,
seen tasks, and unseen tasks specific to different
settings in supervised fine-tuning.

| | Average Accuracy | | |
|---|---|---|---|
| | Overall | Seen | Unseen |
| Untrained | 0.36 | — | 0.36 |
| all-main | 0.67 | 0.9 | 0.12 |
| 1-inst | 0.51 | 0.93 | 0.33 |
| miniAP-held-out | 0.68 | 0.88 | 0.54 |
| all-held-out | 0.41 | — | 0.41 |

TABLE 4
Performance of supervised fine-tuned models. Blue cells
indicate those tasks are held-out in that setting.

| | copy- | copy- | edit- | edit- | miniAP- | miniAP- | miniAP- | | |
|---|---|---|---|---|---|---|---|---|---|
| | 1 | N | 1 | N | 1-1 | N-1 | N-P | UL -1 | UL -N |
| Untrained | 0.97 | 0.99 | 0.06 | 0.0 | 0.47 | 0.53 | 0.1 | 0.15 | 0.02 |
| all-main | 1.0 | 1.0 | 0.86 | 0.56 | 0.99 | 0.97 | 0.93 | 0.24 | 0.04 |
| 1-Inst | 0.97 | 0.41 | 0.83 | 0.01 | 0.98 | 0.89 | 0.22 | 0.51 | 0.07 |
| miniAP- | 1.0 | 1.0 | 0.93 | 0.58 | 0.87 | 0.74 | 0.42 | 0.55 | 0.1 |
| heldout | | | | | | | | | |
| all- | 0.93 | 0.44 | 0.13 | 0.01 | 0.85 | 0.65 | 0.46 | 0.1 | 0.0 |
| heldout | | | | | | | | | |

| | miniAP |
|---|---|
| | (Reversed) |
| Untrained | 0.26 |
| all-main | 0.08 |
| 1-Inst | 0.17 |
| miniAP- | 0.58 |
| heldout | |
| all- | 0.53 |
| heldout | |

On all tasks, in every setting, overall performance improves significantly compared to the baseline. As expected, the gains on the seen tasks are the highest. However, when trained on all seen tasks, significant gains on seen tasks may actually result in a performance drop on unseen tasks (see all-main and 1-Inst settings). This suggests that instruction fine-tuning on a small set of tasks adapts the model more aggressively to those specific tasks, thus limiting generalization to new tasks. There is some evidence that single-instruction fine-tuned models can generalize to apply multiple instructions and outperform the baseline (0.51 vs 0.36). Finally, both settings, which include the GENERIC-TE dataset, significantly boost overall performance, demonstrating that there is value in training on a large and very diverse set of instructions (see miniAP-held-out and all-held-out).

### 6. BENEFITS AND IMPROVEMENTS

Several writers have addressed instruction fine-tuning (Mishra et al., 2022; Iyer et al., 2022; Chung et al., 2022; Taori et al., 2023). However, explicitly evaluating the instruction following the capability of LLMs is relatively scarce (Webson and Pavlick (2022); Kung et al. (2023); Zeng et al. (2023)). Webson and Pavlick (2022) investigate the extent to which prompt-based models understand their prompts. They note that good model predictions are made even when misleading prompts are provided, thus cautioning against attributing model performance to prompt understanding. Similarly, Kung et al. (2023) argue that many instruction fine-tuned models may rely on prompt artifacts like the output format and advise caution against ascribing the superior performance to their instruction-following ability.

The Li et al. (2023) paper investigates models' reliance on prior knowledge encoded during training when following instructions (e.g., instructions on classifying text). They show that model performance deteriorates significantly when instructions deviate from the model's prior knowledge, which the present experiments reinforce. However, their work is mainly concerned with the effect of a model's prior knowledge on performance. The present disclosure, in contrast, comprehensively characterizes the performance of LLMs in following text editing instructions and evaluates the impact of many additional factors like model scale, training data, and instruction complexity.

Zeng et al. (2023) look at a related problem, evaluating the efficacy of “LLM-evaluators,” where an LLM and a prompting strategy are used to rank other LLM model outputs according to some specific criterion like sensitivity. They propose a benchmark called LMBAR for evaluating such evaluators and conclude by noting that many evaluators vary in their preferred outputs, showing significant room for improvement.

Differing from the above, the present disclosure evaluates LLMs' ability to follow fine-grained text editing instructions across various dimensions in a controlled manner. A benchmark suite of tasks consists of elementary text-editing instructions and text-editing instructions derived from popular style guides. The disclosure addresses the effects of various model parameters, which can guide modeling improvements and practical applications.

### 7. DIGITAL STYLE GUIDE APPLICATIONS

The present disclosure introduces a task of “style guide application” and introduces a benchmark for this task. The benchmark comprises an engineered prompt that is capable of causing an LLM to automatically transform a digital electronic document to conform the document to a specified style guide. One example is the AP Style Guide, but others can be used.

### 7.1 Example Style Guide Instructions to Llms

The engineered LLM prompt can state instructions of several types. For example, the prompt can state objective instructions like those of TABLE 5. Additionally, or alternatively, the prompt can state instructions that are subjective and/or related to pragmatic intent, like “Keep the audience in mind and make sure to encourage them to respond,” and/or “Make the text witty and engaging to the audience.”

TABLE 5
List of instructions in the miniAP task.

<styleguide>
<punctuation>
<instruction> Add an apostrophe if using a possessive form of a
plural form ending in s.
</instruction>
<instruction> Add an apostrophe s if using a possessive form of a
plural form not ending in s.
</instruction>
<instruction> Capitalize the first word after a colon if the word
that follows a colon is a proper
noun. </instruction>
<instruction> Capitalize the first word after a colon if what
follows a colon is a complete
sentence.
</instruction>
<instruction> Do not capitalize the first word after a colon if
what follows is a list or a phrase
that does not begin with a proper noun. </instruction>
<instruction> Do not use [ ] but replace them with ( ).
</instruction>
<instruction> Use slash without spaces to signify alternatives and
not a hyphen. </instruction>
</punctuation>
<abbreviation>
<instruction> Abbreviate titles of persons before their name.
</instruction>
<instruction> Abbreviate titles of persons (Junior, Senior) after
their name. </instruction>
</abbreviation>
<dateandtime>
<instruction> Abbreviate years using two digits. When abbreviating
a year with an apostrophe, the
apostrophe should be turned away from the date.
</instruction>
</dateandtime>
<capitalization>
<instruction> Capitalize only proper nouns and product names.
</instruction>
<instruction> Do not capitalize season names except when they are
the first word of a sentence.
</instruction>
</capitalization>
<numbers>
<instruction> For single-digit numbers, write them in words. For
eg. 9 apples => Nine apples.
</instruction>
<instruction> Write numbers with more than 5 digits using groups
of three digits each starting
from the right end. If there is a decimal point, the grouping
should only be on the integer side
of the decimal point. </instruction>
<instruction> Use . as a decimal separator when using the decimal
point. </instruction>
</numbers>
</styleguide>

Embodiments can operate on document units such as sentences, groups of sentences, paragraphs, or complete documents.

### 7.2 Distributed Computer System Example

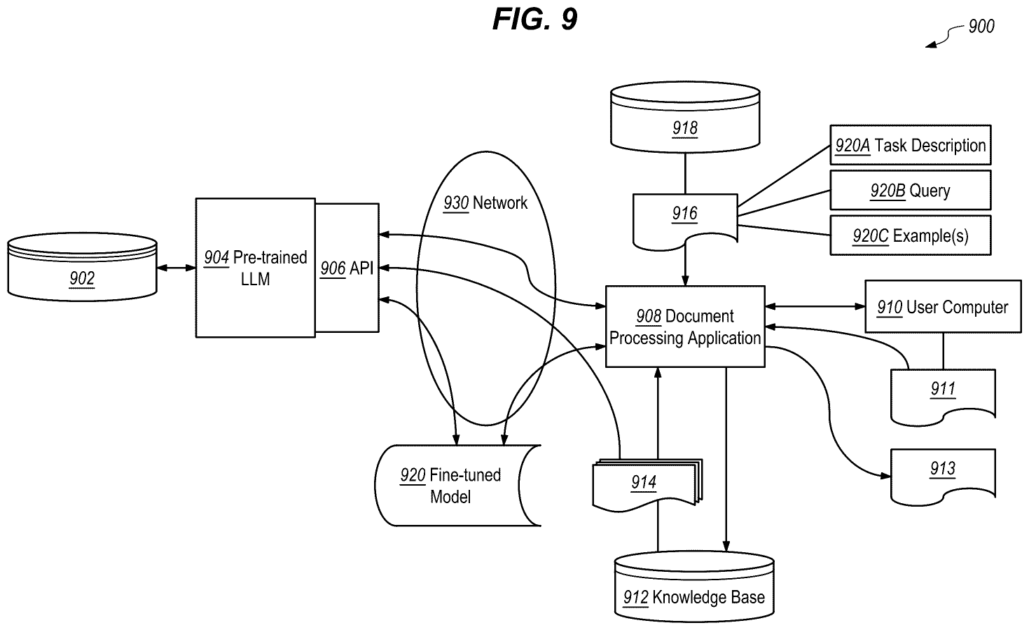

FIG. 9 illustrates a distributed computer system showing the context of use and principal functional elements with which one embodiment could be implemented. In an embodiment, a computer system 900 comprises components implemented partially by hardware at one or more computing devices, such as one or more hardware processors executing stored program instructions stored in one or more memories for performing the functions described herein. In other words, all functions described herein are intended to indicate operations performed using programming in a special or general-purpose computer in various embodiments. FIG. 1 illustrates only one of many possible arrangements of components configured to execute the programming described herein. Other arrangements may include fewer or different components, and the division of work between the components may vary depending on the arrangement.

FIG. 9, and the other drawing figures and all of the description and claims in this disclosure, are intended to present, disclose, and claim a technical system and technical methods in which specially programmed computers, using a special-purpose distributed computer system design, execute functions that have not been available before to provide a practical application of computing technology to the problem of automatically transforming digital electronic documents according to a style guide. In this manner, the disclosure presents a technical solution to a technical problem, and any interpretation of the disclosure or claims to cover any judicial exception to patent eligibility, such as an abstract idea, mental process, method of organizing human activity, or mathematical algorithm, has no support in this disclosure and is erroneous.

In an embodiment, computer system 900 can be programmed to implement a prompt engineering approach, alone or in combination with retrieval-augmented generation (RAG), parameter-efficient fine-tuning (PEFT) with or without low-rank adaptation (LoRA), and/or full fine-tuning. In an embodiment, a large data corpus 902 trains a pre-trained large language model (LLM), which is externally programmatically accessible via an application programming interface (API) 906. Examples of LLM include GPT and LLAMA models, as previously identified and described. Typically the LLM is pre-trained and hosted in a computing environment of a first party, and other elements of the computer system 900 are hosted in other computing environments of other parties, but all elements also can be co-hosted, on-prem or in private, shared, or public cloud computing facilities like AMAZON AWS, GOOGLE CLOUD, and MICROSOFT AZURE, as examples.

A document processing application 908 is communicatively coupled via a network 930 to the API 906 and programmed to execute document processing functions including the automatic transformation of digitally stored electronic documents according to style guides, as described herein. The document processing application 908 may be hosted and/or executed using one or more server computers, server clusters, virtual compute and/or virtual storage instances, or a combination thereof, hosted on-prem at an enterprise or in a public or private data center or cloud computing environment.

In an embodiment, one or more user computers 910 are coupled to the document processing application 908 and can select, activate, and use one or more features or functions of the document processing application. Each of the user computer 910 can comprise any of a laptop computer, desktop computer, workstation, tablet computing device, smartphone, smart watch, or any other computer that is practical to use for text composition, editing, and display. In an embodiment, the user computer 910 hosts or executes an application program such as a browser or word processor to create and store an electronic document 911. The electronic document 911 can be locally stored using a storage device of the user computer 910, or stored in a hosted storage environment such as DROPBOX, BOX, GOOGLE DRIVE, MICROSOFT ONEDRIVE.

For a clear example, assume that the electronic document 911 does not conform to a specified style guide. As further described in other sections, the user computer 910 can invoke functions of the document processing application 908 to present the electronic document 911 to the pre-trained LLM 904, alone or in combination with other relevant documents 914, and an engineered prompt 916. As further described in other sections, in response, the pre-trained LLM 904 and/or fine-tuned model 920 execute an inference stage over the electronic document 911 and automatically generate output text 913 based on the electronic document that transforms it to conform to the specified style guide. In various embodiments, the output text 913 can be locally stored using a storage device of the user computer 910, stored in a hosted storage environment such as DROPBOX, BOX, GOOGLE DRIVE, MICROSOFT ONEDRIVE, or stored in memory associated with document processing application 908 or in any memory associated with it.

A knowledge base 912 can digitally store electronic documents, such as text documents that the user computer 910 has created and stored, in states before or after transformation according to a digital style guide. In one embodiment, the document processing application 908 can be programmed to implement search query functions or document query functions by which the user computer 910 can enter or present a query for one or more documents that conform to a specified style guide. In response, the knowledge base 912 creates and returns a result set of relevant documents 914. In one mode of operation, the relevant documents 914 can be input via API 906 to the pre-trained LLM 904 with a request or prompt to fine-tune the LLM, thereby causing the pre-trained LLM to create and return, or digitally store, a fine-tuned model 920. Thereafter, the fine-tuned model 920 can receive an electronic document as input and process a request to automatically transform the electronic document according to the specified style guide. In this manner and based on the experiments that have been previously described, the fine-tuned model 920 will more accurately transform a particular electronic document to conform to the specified style guide.

In an embodiment, the computer system 900 can also operate in a zero-shot mode, in which an engineered prompt 916 is presented to the pre-trained LLM 904 to cause the transformation of an electronic document to conform to a style guide that is partly or fully represented in the text of the engineered prompt. In an embodiment, the engineered prompt 916 shown in FIG. 9 may be one of a plurality of different prompts digitally stored in prompt storage 918 and retrieved in response to a programmatic request from the document processing application 908. In an embodiment, the engineered prompt 916 comprises a task description 920A, query 920B, and optionally one or more examples 920C of transformations. TABLE 5 is an example of an engineered prompt that combines aspects of task descriptions and queries in the form of unified instructions, but separately structured elements can be used.

In one embodiment, the document processing application 908 can implement a retrieval-augmented generation (RAG) mode of operation. In the RAG operation, the document processing application 908 is programmed to transmit a query to the knowledge base 912 to retrieve a result set of relevant documents 914 corresponding to prior transformations of documents according to a specified style guide. The document processing application 908 is further programmed to transmit a processing request to the API 906, the processing request comprising:
1. A copy of the electronic document to be transformed according to the specified style guide;
2. The result set of one or more relevant documents 914; and
3. The engineered prompt 916.

With this information, the pre-trained LLM 904 will process the input electronic document to be transformed and return automatically generated text that has been transformed according to the style guide. In all the foregoing examples, the specified style guide can comprise one particular, named style guide among a plurality of different available style guides. The document processing application 908 can be programmed to automatically select the RAG approach, fine-tuned training approach, or prompt-based approach based on a plurality of factors such as the availability or cost of using the pre-trained LLM 904 as compared to other available LLMs, a response time parameter that the user computer 910 has entered or selected using the document processing application 908, the length of the input document, and so forth.

Each of the prompt storage 918, the knowledge base 912, and the corpus 902 can be digitally stored using one or more virtual storage instances, digital storage devices, relational databases, object databases, or flat file systems. They may be co-located and co-hosted or independent.

Network 930 broadly represents any combination of one or more local area networks, wide area networks, campus networks, and/or internetworks using any of wired or wireless, satellite or terrestrial communications links. Lines in FIG. 9 broadly represent data paths and/or wired or wireless communications paths, which may be direct, indirect, or networked.

### 8. IMPLEMENTATION EXAMPLE-HARDWARE OVERVIEW

According to one embodiment, the techniques described herein are implemented by at least one computing device. The techniques may be implemented in whole or in part using a combination of at least one server computer and/or other computing devices coupled using a network, such as a packet data network. The computing devices may be hard-wired to perform the techniques or may include digital electronic devices such as at least one application-specific integrated circuit (ASIC) or field programmable gate array (FPGA) that is persistently programmed to perform the techniques or may include at least one general purpose hardware processor programmed to perform the techniques pursuant to program instructions in firmware, memory, other storage, or a combination. To accomplish the described techniques, such computing devices may combine custom hard-wired logic, ASICs, or FPGAs with custom programming. The computing devices may be server computers, workstations, personal computers, portable computer systems, handheld devices, mobile computing devices, wearable devices, body-mounted or implantable devices, smartphones, smart appliances, internetworking devices, autonomous or semi-autonomous devices such as robots or unmanned ground or aerial vehicles, any other electronic device that incorporates hard-wired and/or program logic to implement the described techniques, one or more virtual computing machines or instances in a data center, and/or a network of server computers and/or personal computers.

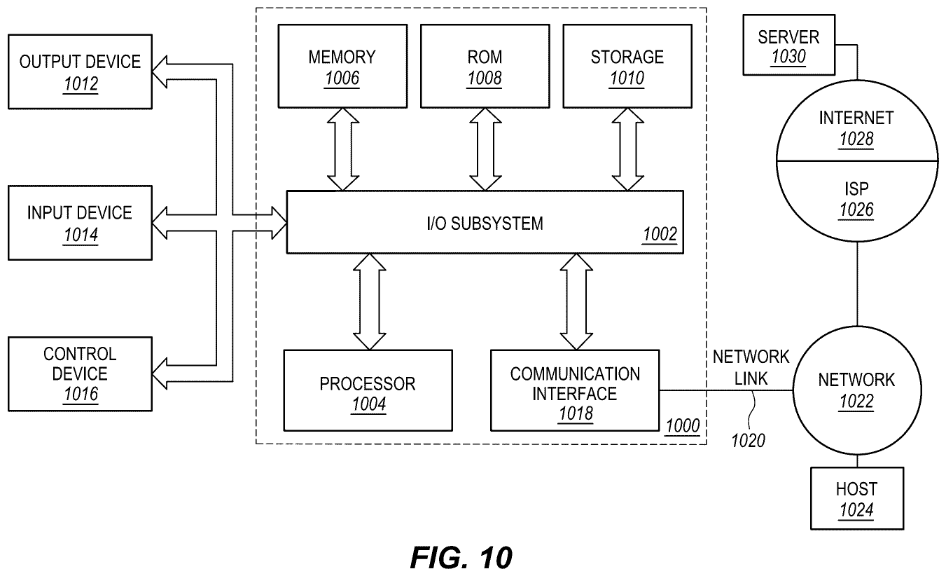

FIG. 10 is a block diagram that illustrates an example computer system with which an embodiment may be implemented. In the example of FIG. 10, a computer system 1000 and instructions for implementing the disclosed technologies in hardware, software, or a combination of hardware and software, are represented schematically, for example, as boxes and circles, at the same level of detail that is commonly used by persons of ordinary skill in the art to which this disclosure pertains for communicating about computer architecture and computer systems implementations.

Computer system 1000 includes an input/output (I/O) subsystem 1002, which may include a bus and/or other communication mechanism(s) for communicating information and/or instructions between the components of the computer system 1000 over electronic signal paths. The I/O subsystem 1002 may include an I/O controller, a memory controller, and at least one I/O port. The electronic signal paths are represented schematically in the drawings, such as lines, unidirectional arrows, or bidirectional arrows.

At least one hardware processor 1004 is coupled to I/O subsystem 1002 for processing information and instructions. Hardware processor 1004 may include, for example, a general-purpose microprocessor or microcontroller and/or a special-purpose microprocessor such as an embedded system or a graphics processing unit (GPU), or a digital signal processor or ARM processor. Processor 1004 may comprise an integrated arithmetic logic unit (ALU) or be coupled to a separate ALU.

Computer system 1000 includes one or more units of memory 1006, such as a main memory, coupled to I/O subsystem 1002 for electronically digitally storing data and instructions to be executed by processor 1004. Memory 1006 may include volatile memory such as various forms of random-access memory (RAM) or other dynamic storage device. Memory 1006 also may be used for storing temporary variables or other intermediate information during the execution of instructions to be executed by processor 1004. Such instructions, when stored in non-transitory computer-readable storage media accessible to processor 1004, can render computer system 1000 into a special-purpose machine customized to perform the operations specified in the instructions.

Computer system 1000 includes non-volatile memory such as read-only memory (ROM) 1008 or other static storage devices coupled to I/O subsystem 1002 for storing information and instructions for processor 1004. The ROM 1008 may include various forms of programmable ROM (PROM), such as erasable PROM (EPROM) or electrically erasable PROM (EEPROM). A unit of persistent storage 1010 may include various forms of non-volatile RAM (NVRAM), such as FLASH memory, solid-state storage, magnetic disk, or optical disks such as CD-ROM or DVD-ROM and may be coupled to I/O subsystem 1002 for storing information and instructions. Storage 1010 is an example of a non-transitory computer-readable medium that may be used to store instructions and data, which, when executed by the processor 1004, causes performing computer-implemented methods to execute the techniques herein.

The instructions in memory 1006, ROM 1008, or storage 1010 may comprise one or more instructions organized as modules, methods, objects, functions, routines, or calls. The instructions may be organized as one or more computer programs, operating system services, or application programs, including mobile apps. The instructions may comprise an operating system and/or system software; one or more libraries to support multimedia, programming, or other functions; data protocol instructions or stacks to implement TCP/IP, HTTP, or other communication protocols; file format processing instructions to parse or render files coded using HTML, XML, JPEG, MPEG or PNG; user interface instructions to render or interpret commands for a graphical user interface (GUI), command-line interface or text user interface; application software such as an office suite, internet access applications, design and manufacturing applications, graphics applications, audio applications, software engineering applications, educational applications, games or miscellaneous applications. The instructions may implement a web server, web application server, or web client. The instructions may be organized as a presentation, application, and data storage layer, such as a relational database system using a structured query language (SQL) or no SQL, an object store, a graph database, a flat file system, or other data storage.

Computer system 1000 may be coupled via I/O subsystem 1002 to at least one output device 1012. In one embodiment, output device 1012 is a digital computer display. Examples of a display that may be used in various embodiments include a touchscreen display, a light-emitting diode (LED) display, a liquid crystal display (LCD), or an e-paper display. Computer system 1000 may include other type(s) of output devices 1012, alternatively or in addition to a display device. Examples of other output devices 1012 include printers, ticket printers, plotters, projectors, sound cards or video cards, speakers, buzzers or piezoelectric devices or other audible devices, lamps or LED or LCD indicators, haptic devices, actuators or servos.

At least one input device 1014 is coupled to I/O subsystem 1002 for communicating signals, data, command selections, or gestures to processor 1004. Examples of input devices 1014 include touch screens, microphones, still and video digital cameras, alphanumeric and other keys, keypads, keyboards, graphics tablets, image scanners, joysticks, clocks, switches, buttons, dials, slides, and/or various types of sensors such as force sensors, motion sensors, heat sensors, accelerometers, gyroscopes, and inertial measurement unit (IMU) sensors and/or various types of transceivers such as wireless, such as cellular or Wi-Fi, radio frequency (RF) or infrared (IR) transceivers and Global Positioning System (GPS) transceivers.

Another type of input device is a control device 1016, which may perform cursor control or other automated control functions such as navigation in a graphical interface on a display screen, alternatively or in addition to input functions. The control device 1016 may be a touchpad, a mouse, a trackball, or cursor direction keys for communicating direction information and command selections to processor 1004 and for controlling cursor movement on an output device 1012, such as a display. The input device may have at least two degrees of freedom in two axes, a first axis (e.g., x) and a second axis (e.g., y), that allows the device to specify positions in a plane. Another type of input device is a wired, wireless, or optical control device such as a joystick, wand, console, steering wheel, pedal, gearshift mechanism, or other control device. An input device 1014 may include a combination of multiple input devices, such as a video camera and a depth sensor.

In another embodiment, computer system 1000 may comprise an Internet of Things (IoT) device in which one or more of the output device 1012, input device 1014, and control device 1016 are omitted. Or, in such an embodiment, the input device 1014 may comprise one or more cameras, motion detectors, thermometers, microphones, seismic detectors, other sensors or detectors, measurement devices or encoders, and the output device 1012 may comprise a special-purpose display such as a single-line LED or LCD display, one or more indicators, a display panel, a meter, a valve, a solenoid, an actuator or a servo.

When computer system 1000 is a mobile computing device, input device 1014 may comprise a global positioning system (GPS) receiver coupled to a GPS module that is capable of triangulating to a plurality of GPS satellites, determining and generating geo-location or position data such as latitude-longitude values for a geophysical location of the computer system 1000. Output device 1012 may include hardware, software, firmware, and interfaces for generating position reporting packets, notifications, pulse or heartbeat signals, or other recurring data transmissions that specify a position of the computer system 1000, alone or in combination with other application-specific data, directed toward host computer 1024 or server computer 1030.

Computer system 1000 may implement the techniques described herein using customized hard-wired logic, at least one ASIC or FPGA, firmware, and/or program instructions or logic which, when loaded and used or executed in combination with the computer system, causes or programs the computer system to operate as a special-purpose machine. According to one embodiment, the techniques herein are performed by computer system 1000 in response to processor 1004 executing at least one sequence of at least one instruction in main memory 1006. Such instructions may be read into main memory 1006 from another storage medium, such as storage 1010. Execution of the sequences of instructions contained in main memory 1006 causes processor 1004 to perform the process steps described herein. In alternative embodiments, hard-wired circuitry may be used in place of or in combination with software instructions.

The term “storage media,” as used herein, refers to any non-transitory media that store data and/or instructions that cause a machine to operate in a specific fashion. Such storage media may comprise non-volatile media and/or volatile media. Non-volatile media includes, for example, optical or magnetic disks, such as storage 1010. Volatile media includes dynamic memory, such as memory 1006. Common forms of storage media include, for example, a hard disk, solid state drive, flash drive, magnetic data storage medium, any optical or physical data storage medium, memory chip, or the like.

Storage media is distinct but may be used with transmission media. Transmission media participates in transferring information between storage media. For example, transmission media includes coaxial cables, copper wire and fiber optics, and wires comprising a bus of I/O subsystem 1002. Transmission media can also be acoustic or light waves generated during radio-wave and infrared data communications.

Various forms of media may carry at least one sequence of at least one instruction to processor 1004 for execution. For example, the instructions may initially be carried on a remote computer's magnetic disk or solid-state drive. The remote computer can load the instructions into its dynamic memory and send them over a communication link such as a fiber optic, coaxial cable, or telephone line using a modem. A modem or router local to computer system 1000 can receive the data on the communication link and convert the data to a format that can be read by computer system 1000. For instance, a receiver such as a radio frequency antenna or an infrared detector can receive the data carried in a wireless or optical signal, and appropriate circuitry can provide the data to I/O subsystem 1002, such as placing the data on a bus. I/O subsystem 1002 carries the data to memory 1006, from which processor 1004 retrieves and executes the instructions. The instructions received by memory 1006 may optionally be stored on storage 1010 either before or after execution by processor 1004.

Computer system 1000 also includes a communication interface 1018 coupled to a bus or I/O subsystem 502. Communication interface 1018 provides a two-way data communication coupling to a network link(s) 1020 directly or indirectly connected to at least one communication network, such as a network 1022 or a public or private cloud on the Internet. For example, communication interface 1018 may be an Ethernet networking interface, integrated-services digital network (ISDN) card, cable modem, satellite modem, or a modem to provide a data communication connection to a corresponding type of communications line, for example, an Ethernet cable or a metal cable of any kind or a fiber-optic line or a telephone line. Network 1022 broadly represents a local area network (LAN), wide-area network (WAN), campus network, internetwork, or any combination thereof. Communication interface 1018 may comprise a LAN card to provide a data communication connection to a compatible LAN, a cellular radiotelephone interface that is wired to send or receive cellular data according to cellular radiotelephone wireless networking standards, or a satellite radio interface that is wired to send or receive digital data according to satellite wireless networking standards. In any such implementation, communication interface 1018 sends and receives electrical, electromagnetic, or optical signals over signal paths that carry digital data streams representing various types of information.

Network link 1020 typically provides electrical, electromagnetic, or optical data communication directly or through at least one network to other data devices, using, for example, satellite, cellular, Wi-Fi, or BLUETOOTH technology. For example, network link 1020 may connect through network 1022 to a host computer 1024.

Furthermore, network link 1020 may connect through network 1022 or to other computing devices via internetworking devices and/or computers operated by an Internet Service Provider (ISP) 1026. ISP 1026 provides data communication services through a worldwide packet data communication network called Internet 1028. A server computer 1030 may be coupled to Internet 1028. Server computer 1030 broadly represents any computer, data center, virtual machine, or virtual computing instance with or without a hypervisor or computer executing a containerized program system such as DOCKER or KUBERNETES. Server computer 1030 may represent an electronic digital service that is implemented using more than one computer or instance, and that is accessed and used by transmitting web services requests, uniform resource locator (URL) strings with parameters in HTTP payloads, API calls, app services calls, or other service calls. Computer system 1000 and server computer 1030 may form elements of a distributed computing system that includes other computers, a processing cluster, a server farm, or other organizations of computers that cooperate to perform tasks or execute applications or services. Server computer 1030 may comprise one or more instructions organized as modules, methods, objects, functions, routines, or calls. The instructions may be organized as one or more computer programs, operating system services, or application programs, including mobile apps. The instructions may comprise an operating system and/or system software; one or more libraries to support multimedia, programming, or other functions; data protocol instructions or stacks to implement TCP/IP, HTTP, or other communication protocols; file format processing instructions to parse or render files coded using HTML, XML, JPEG, MPEG or PNG; user interface instructions to render or interpret commands for a graphical user interface (GUI), command-line interface or text user interface; application software such as an office suite, internet access applications, design and manufacturing applications, graphics applications, audio applications, software engineering applications, educational applications, games or miscellaneous applications. Server computer 1030 may comprise a web application server that hosts a presentation layer, application layer, and data storage layer, such as a relational database system using a structured query language (SQL) or no SQL, an object store, a graph database, a flat file system or other data storage.

Computer system 1000 can send messages and receive data and instructions, including program code, through the network(s), network link 1020, and communication interface 1018. In the Internet example, server computer 1030 might transmit a requested code for an application program through Internet 1028, ISP 1026, local network 1022, and communication interface 1018. The received code may be executed by processor 1004 as it is received and/or stored in storage 1010 or other non-volatile storage for later execution.

The execution of instructions, as described in this section, may implement a process in the form of an instance of a computer program that is being executed and consists of a program code and its current activity. Depending on the operating system (OS), a process may comprise multiple threads of execution that execute instructions concurrently. In this context, a computer program is a passive collection of instructions, while a process may be executing those instructions. Several processes may be associated with the same program; for example, opening up several instances of the same program often means more than one process is being executed. Multitasking may be implemented to allow multiple processes to share processor 1004. While each processor 1004 or core of the processor executes a single task at a time, computer system 1000 may be programmed to implement multitasking to allow each processor to switch between tasks that are being executed without having to wait for each task to finish. In an embodiment, switches may be performed when tasks perform input/output operations when a task indicates that it can be switched or on hardware interrupts. Time-sharing may be implemented to allow fast response for interactive user applications by rapidly performing context switches to provide the appearance of concurrent execution of multiple processes. In an embodiment, for security and reliability, an operating system may prevent direct communication between independent processes, providing strictly mediated and controlled inter-process communication functionality.

In the foregoing specification, embodiments of the invention have been described with reference to numerous specific details that may vary from implementation to implementation. Accordingly, the specification and drawings are to be regarded in an illustrative rather than a restrictive sense. The sole and exclusive indicator of the scope of the invention, and what is intended by the applicants to be the scope of the invention, is the literal and equivalent scope of the set of claims that issue from this application, in the specific form in which such claims issue, including any subsequent correction.

### 9. REFERENCES

Hyung Won Chung, Le Hou, Shayne Longpre, Barret Zoph, Yi Tay, William Fedus, Yunxuan Li, Xuczhi Wang, Mostafa Dehghani, Siddhartha Brahma, et al. 2022. Scaling instruction-finetuned language models. arXiv preprint arXiv: 2210.11416.
Dan Hendrycks, Collin Burns, Steven Basart, Andy Zou, Mantas Mazeika, Dawn Song, and Jacob Steinhardt. 2020. Measuring massive multitask language understanding. arXiv preprint arXiv: 2009.03300.
Srinivasan Iyer, Xi Victoria Lin, Ramakanth Pasunuru, Todor Mihaylov, Daniel Simig, Ping Yu, Kurt Shuster, Tianlu Wang, Qing Liu, Punit Singh Koura, et al. 2022. Opt-iml: Scaling language model instruction meta learning through the lens of generalization. arXiv preprint arXiv: 2212.12017.
Po-Nien Kung and Nanyun Peng. 2023. Do models really learn to follow instructions? an empirical study of instruction tuning. In Proceedings of the 61st Annual Meeting of the Association for Computational Linguistics (Volume 2: Short Papers), pages 1317-1328, Toronto, Canada. Association for Computational Linguistics.
Po-Nien Kung et al. 2023. Do models really learn to follow instructions? an empirical study of instruction tuning. In Proceedings of the 61st Annual Meeting of the Association for Computational Linguistics (Volume 2: Short Papers), pages 1317-1328, Toronto, Canada. Association for Computational Linguistics.
Shiyang Li, Jun Yan, Hai Wang, Zheng Tang, Xiang Ren, Vijay Srinivasan, and Hongxia Jin. 2023. Instruction-following evaluation through verbalizer manipulation. arXiv preprint arXiv: 2307.10558.
Nelson F Liu, Kevin Lin, John Hewitt, Ashwin Paran-jape, Michele Bevilacqua, Fabio Petroni, and Percy Liang. 2023. Lost in the middle: How language models use long contexts. arXiv preprint arXiv: 2307.03172.
R Thomas McCoy, Shunyu Yao, Dan Friedman, Matthew Hardy, and Thomas L Griffiths. 2023. Embers of autoregression: Understanding large language models through the problem they are trained to solve. arXiv preprint arXiv: 2309.13638.
Sewon Min, Xinxi Lyu, Ari Holtzman, Mikel Artetxe, Mike Lewis, Hannanch Hajishirzi, and Luke Zettle-moyer. 2022. Rethinking the role of demonstrations: What makes in-context learning work? In Proceedings of the 2022 Conference on Empirical Methods in Natural Language Processing, pages 11048-11064, Abu Dhabi, United Arab Emirates. Association for Computational Linguistics.
Swaroop Mishra, Daniel Khashabi, Chitta Baral, and Hannanch Hajishirzi. 2022. Cross-task generalization via natural language crowdsourcing instructions. In Proceedings of the 60th Annual Meeting of the Association for Computational Linguistics (Volume 1: Long Papers), pages 3470-3487, Dublin, Ireland. Association for Computational Linguistics.
Nigar M Shafiq Surameery and Mohammed Y Shakor. 2023. Use chat gpt to solve programming bugs. International Journal of Information Technology & Computer Engineering (IJITC) ISSN: 2455-5290, 3 (01): 17-22.
Rohan Taori, Ishaan Gulrajani, Tianyi Zhang, Yann Dubois, Xuechen Li, Carlos Guestrin, Percy Liang, and Tatsunori B. Hashimoto. 2023. Stanford alpaca: An instruction-following llama model.
Alex Wang, Yada Pruksachatkun, Nikita Nangia, Aman-preet Singh, Julian Michael, Felix Hill, Omer Levy, and Samuel Bowman. 2019. Superglue: A stickier benchmark for general-purpose language understanding systems. Advances in neural information processing systems, 32.
Alex Wang, Amanpreet Singh, Julian Michael, Felix Hill, Omer Levy, and Samuel R Bowman. 2018. Glue: A multi-task benchmark and analysis platform for natural language understanding. arXiv preprint arXiv: 1804.07461.
Yizhong Wang, Yeganeh Kordi, Swaroop Mishra, Al-isa Liu, Noah A Smith, Daniel Khashabi, and Han-naneh Hajishirzi. 2022. Self-instruct: Aligning language model with self generated instructions. arXiv preprint arXiv: 2212.10560.
Albert Webson and Ellie Pavlick. 2022. Do prompt-based models really understand the meaning of their prompts? In Proceedings of the 2022 Conference of the North American Chapter of the Association for Computational Linguistics: Human Language Technologies, pages 2300-2344, Seattle, United States. Association for Computational Linguistics.
Zhiyuan Zeng, Jiatong Yu, Tianyu Gao, Yu Meng, Tanya Goyal, and Danqi Chen. 2023. Evaluating large language models at evaluating instruction following. arXiv preprint arXiv: 2310.07641.

What is claimed is:

1. A computer system, comprising:
one or more virtual compute instances executing a document processing application and programmatically coupled via a network to a fine-tuned model and an application programming interface (API) of a pre-trained large language model (LLM); and
one or more virtual storage instances coupled to the one or more virtual compute instances and comprising one or more non-transitory computer-readable storage media storing one or more sequences of instructions which, when executed using one or more processors, cause the one or more processors to execute:
receiving a digitally stored electronic document, alone or in combination with one or more other relevant documents, and an engineered prompt;
transmitting an API call to the API of the pre-trained LLM, wherein the API call comprises the engineered prompt, wherein the engineered prompt comprises a plurality of objective instructions to the pre-trained LLM specifying transforming the electronic document according to a style guide to cause the pre-trained LLM to execute an inference stage over the electronic document and automatically generate output text based on the electronic document and the plurality of objective instructions that transforms the electronic document to conform to the style guide; and
storing the output text using a storage device of a user computer, a hosted storage environment, or in memory associated with the document processing application.

2. The computer system of claim 1, wherein the pre-trained large language model (LLM) is any of a ChatGPT model, a GPT4 model, and a LLAMA2-13B model.

3. The computer system of claim 1, wherein the one or more virtual compute instances are communicatively coupled via the network to the user computer, which hosts or executes a browser or word processor to create and store the electronic document.

4. The computer system of claim 3, further comprising:
a knowledge base that digitally stores text documents that the user computer has created and stored in states before or after transformation according to the style guide;
wherein the one or more virtual storage instances further comprise sequences of instructions which, when executed using the one or more processors, cause the one or more processors to execute:
receiving a query for one or more documents that conform to a specified style guide;
in response to the query, creating and returning a result set of the one or more other relevant documents;
transmitting the one or more other relevant documents via the API to the pre-trained LLM with a prompt to fine-tune the LLM, thereby causing the pre-trained LLM to create and return, or digitally store, the fine-tuned model; and
using the fine-tuned model, receiving the electronic document as input and processing a request to automatically transform the electronic document according to the specified style guide.

5. The computer system of claim 4, wherein the one or more virtual storage instances further comprise sequences of instructions which, when executed using the one or more processors, cause the one or more processors to execute:
transmitting a query to the knowledge base to retrieve a result set of the one or more other relevant documents corresponding to prior transformations of documents according to a specified style guide;
transmitting a processing request to the API, the processing request comprising: a copy of the electronic document to be transformed according to the specified style guide; the result set of the one or more other relevant documents; and the engineered prompt; and
receiving, from the pre-trained LLM, automatically generated text that has been transformed according to the style guide.

6. The computer system of claim 1, wherein the engineered prompt comprises one of a plurality of different prompts digitally stored in prompt storage and retrieved in response to a programmatic request from the document processing application.

7. The computer system of claim 1, wherein the engineered prompt comprises a task description, a query, and a plurality of examples of transformations.

8. The computer system of claim 7, wherein the engineered prompt comprises 10 to 1,000 examples of transformations.

9. The computer system of claim 1, wherein the engineered prompt comprises a task description, a query, and at least:
one or more first instructions specifying punctuation usage;
one or more second instructions specifying abbreviation style;
one or more third instructions specifying capitalization style; and
one or more fourth instructions specifying number style.

10. The computer system of claim 1, wherein the engineered prompt comprises 6 to 16 instructions.

11. The computer system of claim 1, wherein the digitally stored electronic document comprises five or fewer sentences.

12. The computer system of claim 1, wherein the pre-trained LLM comprises 70 billion or more parameters.

13. One or more non-transitory computer-readable storage media storing one or more sequences of instructions which, when executed using one or more processors, cause the one or more processors to execute:
executing a document processing application;
receiving a digitally stored electronic document, alone or in combination with one or more other relevant documents, and an engineered prompt;
transmitting an application programming interface (API) call to an API of a pre-trained large language model (LLM), wherein the API call comprises the engineered prompt, wherein the engineered prompt comprises a plurality of objective instructions to the pre-trained LLM specifying transforming the electronic document according to a style guide to cause the pre-trained LLM to execute an inference stage over the electronic document and automatically generate output text based on the electronic document and the plurality of objective instructions that transforms the electronic document to conform to the style guide; and
storing the output text using a storage device of a user computer, a hosted storage environment, or in memory associated with the document processing application.

14. The one or more non-transitory computer-readable storage media of claim 13, wherein the pre-trained LLM is any of a ChatGPT model, a GPT4 model, and a LLAMA2-13B model.

15. The one or more non-transitory computer-readable storage media of claim 13, wherein the document processing application is communicatively coupled via a network to the user computer, which hosts or executes a browser or word processor to create and store the electronic document.

16. The one or more non-transitory computer-readable storage media of claim 15, further comprising sequences of instructions which, when executed using the one or more processors, cause the one or more processors to execute:
receiving a query for one or more documents that conform to a specified style guide;
transmitting the query to a knowledge base that digitally stores text documents that the user computer has created and stored in states before or after transformation according to the style guide;
in response to the query, creating and returning a result set of the one or more other relevant documents;
transmitting the one or more other relevant documents via the API to the pre-trained LLM with a prompt to fine-tune the LLM, thereby causing the pre-trained LLM to create and return, or digitally store, a fine-tuned model; and
using the fine-tuned model, receiving the electronic document as input and processing a request to automatically transform the electronic document according to the specified style guide.

17. The one or more non-transitory computer-readable storage media of claim 16, further comprising sequences of instructions which, when executed using the one or more processors, cause the one or more processors to execute:
transmitting a query to the knowledge base to retrieve a result set of the one or more other relevant documents corresponding to prior transformations of documents according to a specified style guide;
transmitting a processing request to the API, the processing request comprising: a copy of the electronic document to be transformed according to the specified style guide; the result set of the one or more other relevant documents; and the engineered prompt; and
receiving, from the pre-trained LLM, automatically generated text that has been transformed according to the style guide.

18. The one or more non-transitory computer-readable storage media of claim 13, wherein the engineered prompt comprises one of a plurality of different prompts digitally stored in prompt storage and retrieved in response to a programmatic request from the document processing application.

19. The one or more non-transitory computer-readable storage media of claim 13, wherein the engineered prompt comprises a task description, a query, and a plurality of examples of transformations.

20. The one or more non-transitory computer-readable storage media of claim 19, wherein the engineered prompt comprises 10 to 1,000 examples of transformations.

21. The one or more non-transitory computer-readable storage media of claim 13, wherein the engineered prompt comprises a task description, a query, and at least:
one or more first instructions specifying punctuation usage;
one or more second instructions specifying abbreviation style;
one or more third instructions specifying capitalization style; and
one or more fourth instructions specifying number style.

22. The one or more non-transitory computer-readable storage media of claim 13, wherein the engineered prompt comprises 6 to 16 instructions.

23. The one or more non-transitory computer-readable storage media of claim 13, wherein the digitally stored electronic document comprises five or fewer sentences.

24. The one or more non-transitory computer-readable storage media of claim 13, wherein the pre-trained LLM comprises 70 billion or more parameters.
